(19) United States
(12) Patent Application Publication
(10) Pub. No.: US 2003/0108475 A1
(43) Pub. Date: Jun. 12, 2003

(54) Carbonaceous material for hydrogen storage and method for preparation thereof, carbonaceous material having hydrogen absorbed therein and method for preparation thereof, cell and fuel using carbonaceous material having hydrogen absorbed therein

(76) Inventors: Eisuke Negishi, Tokyo (JP); Masafumi Ata, Kanagawa (JP); Masashi Shiraishi, Tokyo (JP); Hisashi Kajiura, Kanagawa (JP)

Correspondence Address: BELL, BOYD & LLOYD, LLC, P. O. BOX 1135, CHICAGO, IL, 60690-1135, US

(21) Appl. No.: 10/221,874

(22) PCT Filed: Mar. 16, 2001
(86) PCT No.: PCT/JP01/02126

(30) Foreign Application Priority Data
Mar. 16, 2000 (JP) 2000-74381

(51) Int. Cl. H01M 4/58; H01M 4/90

(52) U.S. Cl. 423/445 R; 429/231.8; 429/218.2; 429/40

(57) ABSTRACT

A hydrogen-storing carbonaceous material is obtained by heating a carbonaceous material before hydrogen is stored under the pressure of hydrogen lower than 50 atmospheric pressure. A hydrogen-stored carbonaceous material is obtained by hydrogen storage in the hydrogen-storing carbonaceous material under the pressure of hydrogen lower than 50 atmospheric pressure. This hydrogen-stored carbonaceous material is used for a battery or a fuel cell. The hydrogen-stored carbonaceous material is heated before the hydrogen is stored under the pressure of hydrogen lower than 50 atmospheric pressure, so that the hydrogen-storing carbonaceous material whose hydrogen storage capacity is extremely improved is produced.

### TECHNICAL FIELD

The present invention relates to a hydrogen-storing carbonaceous material and a method for producing it, a hydrogen-stored carbonaceous material and a method for producing it and a battery and a fuel cell using a hydrogen-stored carbonaceous material, and more particularly to a hydrogen-storing carbonaceous material and a method for producing it, a hydrogen-stored carbonaceous material and a method for producing it and a battery using the carbonaceous-stored carbonaceous material and a fuel cell using the hydrogen-stored carbonaceous material which are light, can be repeatedly used, be safe and may not possibly cause problems in view of resources and an environment.

### BACKGROUND ART

There has been hitherto widely employed fossil fuel such as gasoline, light oil, etc. as the energy source for producing an electric power as well as the energy source of motor vehicles or the like. The fossil fuel not only may possibly degrade a global environment, but also is exhaustible and dubious whether or not the fossil fuel can be stably supplied.

Hydrogen has been paid attention to in place of the fossil fuel having the above described possibilities. The hydrogen is contained in water, inexhaustibly exists on the earth and includes a large quantity of chemical energy per amount of material. Further, the hydrogen has advantages as a clean and inexhaustible energy source by which the fossil fuel is replaced, because the hydrogen does not discharge harmful substances or global greenhouse gas or the like when it is used as the energy source.

Especially recently, the fuel cell that an electric energy can be taken out from the hydrogen energy has been eagerly studied and developed and it has been expected that the fuel cell is applied to a large-scale power generation, an onsite private power generation, and further, to a power supply for a motor vehicle.

On the other hand, since the hydrogen is gaseous under ambient temperature and ambient pressure, it is treated with more difficulty than liquid or solid. Since the density of the gas is extremely small as compared with that of liquid or solid, the chemical energy of the gas is small per volume. Further, it is inconveniently difficult to store or transport the gas. Still further, since the hydrogen is gas, it is liable to leak. When the hydrogen leaks, the danger of explosion is undesirably generated, which results in a great trouble in utilization of the hydrogen energy.

Thus, in order to put an energy system using the hydrogen energy to practical use, the development of a technique that the gaseous hydrogen is efficiently and safely stored in a small volume has been promoted. There have been proposed a method for hydrogen storage as high pressure gas, a method for hydrogen storage as liquefied hydrogen and a method for using a hydrogen-storing material, or the like.

In the method for hydrogen storage as the high pressure gas, since a very strong metallic pressure proof vessel such as a cylinder needs to be used as a storage vessel, the vessel itself becomes extremely heavy and the density of the high pressure gas is ordinarily about 12 mg/cc. Accordingly, not only the storage density of the hydrogen is disadvantageously terribly small and a storage efficiency is low, but also there has a problem in view of safety because of high pressure.

On the contrary, in the method for hydrogen storage as the liquefied hydrogen, the storage density is ordinarily about 70 mg/cc. Although the storage density is considerably high, it is necessary to cool hydrogen down to lower than −250° C. in order to liquefy, so that an additional device such as a cooling device is required. Therefore, not only a system has been undesirably complicated, but also energy for cooling has been needed.

Further, hydrogen-stored alloys are most effective materials among the hydrogen-stored materials. For instance, there have been known lanthanum-nickel, vanadium, and magnesium hydrogen-stored alloys. The practical hydrogen storage density of these hydrogen-stored alloys is generally 100 mg/cc. Although the hydrogen is stored in these hydrogen-stored alloys, the hydrogen storage density of these alloys is not lower than that of liquefied hydrogen. Therefore, the use of the hydrogen-storing materials is the most efficient among conventional hydrogen storage methods. Further, when the hydrogen-storing alloy is used, the hydrogen can be stored in the hydrogen-storing alloy and the hydrogen can be discharged from the hydrogen-storing storing alloy at around room temperature. Further, since the hydrogen storage condition is controlled under the balance of the partial pressure of hydrogen, the hydrogen-storing alloy is advantageously treated more easily than the high pressure gas or the liquefied hydrogen.

However, since the hydrogen-stored alloys consist of metallic alloys, they are heavy and the amount of stored hydrogen is limited to approximately 20 mg/g per unit weight, which may not be said to be sufficient. Further, since the structure of the hydrogen-storing alloy is gradually destroyed in accordance with the repeated the cycle of storing and discharging of hydrogen gas, a performance is undesirably deteriorated. Still further, there may be possibly generated fears of the problems of resources and an environment depending on the composition of the alloy.

Thus, for overcoming the above described issues of the conventional methods for hydrogen storage, a carbon material is paid attention to as the hydrogen-storing material.

For example, Japanese Patent Application Laid-Open No. hei. 5-270801 proposes a method that the addition reaction of hydrogen is applied to fullerene to store hydrogen. In this method, since a chemical bond such as a covalent bond is formed between a carbon atom and a hydrogen atom, this method is to be called an addition of hydrogen rather than a hydrogen storage. Since the upper limit of the amount of hydrogen which can be added by the chemical bonds is essentially restricted to the number of unsaturated bonds of carbon atoms, the amount of stored hydrogen is limited.

Further, Japanese Patent Application Laid-Open No. hei. 10-72291 proposes a technique that fullerene is used as the hydrogen-storing material and the surface of the fullerene is covered with catalytic metal such as platinum deposited by a vacuum method or a sputtering method to store hydrogen. In order to employ platinum as the catalytic metal and cover the surface of fullerene with it, much platinum needs to be used so that not only a cost is increased, but also a problem is generated in view of resources.

The method for hydrogen storage known heretofore is difficult to say as a practical one when hydrogen energy is utilized. Especially, when the hydrogen energy is employed as an energy source for motor vehicles, marine vessels, general domestic power supplies, various kinds of small electric devices, etc. or when a large amount of hydrogen needs to be conveyed, the conventional methods for hydrogen storage is not practical.

### DISCLOSURE OF THE INVENTION

It is an object of the present invention to provide a hydrogen-storing carbonaceous material and a method for producing it, a hydrogen-stored carbonaceous material and a method for producing it and a battery and a fuel cell using a hydrogen-stored carbonaceous material which are light, can be repeatedly used, are safe and may not possibly generate problems in view of resources and an environment.

For achieving the above object of the present invention, the inventors of the present invention eagerly and continuously studied and found that the carbonaceous material was heated before the hydrogen was stored under the pressure of hydrogen lower than 50 atmospheric pressure so that the hydrogen storage capability of the carbonaceous material is outstandingly improved. The hydrogen-storing carbonaceous material according to the present invention was invented on the basis of this knowledge and obtained by heating the carbonaceous material before the hydrogen is stored under the pressure of hydrogen lower than 50 atmospheric pressure.

According to the present invention, since the carbonaceous material is simply heated before the hydrogen is stored under the pressure of hydrogen lower than 50 atmospheric pressure, so that the hydrogen-storing carbonaceous material whose hydrogen storage capacity is extremely improved can be produced, there can be got the hydrogen-storing carbonaceous material which can efficiently store a large amount of hydrogen, is light and can be repeatedly used, is safe and may not possibly generate problems from the viewpoints of resources and an environment.

Further, the hydrogen-storing carbonaceous material according to the present invention is a material obtained by heating the carbonaceous material and storing hydrogen under the pressure of hydrogen lower than 50 atmospheric pressure.

According to the present invention, since the carbonaceous material is simply heated to store the hydrogen under the pressure of hydrogen lower than 50 atmospheric pressure so that the hydrogen-stored carbonaceous material in which a large amount of hydrogen is stored can be produced, there can be obtained the hydrogen-storing carbonaceous material which can efficiently store a large amount of hydrogen, is light, can be repeatedly employed, is safe and may not possibly generate problems in view of resources and an environment.

Further, the present invention concerns a battery having an anode, a cathode, an electrolyte interposed therebetween, and the anode and/or the cathode includes a hydrogen-stored carbonaceous material obtained by heating the carbonaceous material to store the hydrogen under the pressure of hydrogen lower than 50 atmospheric pressure.

In an alkaline storage battery in which aqueous alkaline solution such as potassium hydroxide solution is employed for the electrolyte according to the present invention, a proton moves to the anode from the cathode through the aqueous alkaline solution to store the proton therein during a charge. The proton can be moved to the cathode side from the anode side through the aqueous alkaline solution during a discharge. Further, in a hydrogen-air fuel cell in which perfluorosulfonic acid polymer electrolyte film or the like is used for the electrolyte, a proton previously stored in a hydrogen electrode by a charging or storing process is supplied to an air electrode through the polymer electrolyte film during the discharge. Accordingly, in the battery according to the present invention, an electric power can be stably taken out.

Further, the present invention provides a fuel cell including a laminated structure having an anode, a proton conductor and a cathode, a hydrogen storage part including a hydrogen-stored carbonaceous material obtained by heating a carbonaceous material to store hydrogen under the pressure of hydrogen lower than 50 atmospheric pressure, discharging the hydrogen and supplying it to the anode. Since this fuel cell has the laminated structure of the anode, the proton conductor and the cathode, and the hydrogen storage part including the hydrogen-stored carbonaceous material obtained by heating the carbonaceous material under the pressure of hydrogen lower than 50 atmospheric pressure to store hydrogen, discharging the hydrogen and supplying it to the anode, the hydrogen discharged from the hydrogen storage part produces a proton in accordance with a catalytic action in the anode. The produced proton moves to the cathode together with a proton produced by the proton conductor so that the protons combine with oxygen to produce water and generate an electromotive force. The fuel cell according to the present invention can supply the hydrogen more efficiently than a case in which the hydrogen storage part is not provided and can improve the conductivity of the proton.

In the present invention, the hydrogen stored in the carbonaceous material includes not only hydrogen molecules and hydrogen atoms, but also a proton as the atomic nucleus of hydrogen.

In the present invention, hydrogen is stored in the carbonaceous material under the pressure of hydrogen lower than 10 atmospheric pressure. Since the hydrogen-stored carbonaceous material is produced by storing hydrogen under the pressure of hydrogen lower than 10 atmospheric pressure, not only the structure of a hydrogen storage device can be simplified, but also a hydrogen storage operation can be safely performed.

In the present invention, the carbonaceous material is heated at more than 100° C. The carbonaceous material is preferably heated at lower than 1500° C. Preferably, the carbonaceous material is heated at from 200° C. to 1200° C. Further preferably, the carbonaceous material is heated at from 600° C. to 1200° C. More preferably, the carbonaceous material is heated at from 800° C. to 1000° C.

Further, in the present invention, the carbonaceous material is heated under the atmosphere of inert gas. The inert gas is composed of inert gas selected from a group including nitrogen gas, helium gas, neon gas, argon gas, krypton gas, xenon gas and radon gas.

As the carbonaceous material employed in the present invention, a material having a large surface and structural curvature is selected. The carbonaceous material is composed of a carbonaceous material selected from a group including fullerene, carbon nanofiber, carbon nanotube, carbon soot, nanocapsule, bucky onion and carbon fiber. As the fullerene, any spheroidal carbon molecules may be used and all spheroidal carbon molecules having the number of carbons such as 36, 60, 70, 72, 74, 76, 78, 80, 82, 84, etc. can be utilized.

Further, the carbonaceous material used in the present invention includes on its surface fine particles made of metal or a metallic alloy having a function for separating hydrogen atoms from hydrogen molecules, or further, separating protons and electrons from the hydrogen atoms. The average size of the fine particles made of the metal or the alloy is desirably 1 micron or smaller. As the metal, there is preferably employed metal or an alloy selected from a group including iron, rare earth elements, nickel, cobalt, palladium, rhodium, platinum or alloys composed of one or two or more of these metals.

When the carbonaceous material having the curvature of fullerene, carbon nanofiber, carbon nanotube, carbon soot, nanocapsule, bucky onion and carbon fiber or the like is produced by an arc discharge method, the metal or the alloy thereof is preferably mixed into a graphite rod before the arc discharge. At the time of the arc discharge, the above described metals or the alloys thereof are allowed to exist, the yield of the carbonaceous material can be enhanced and the hydrogen-storing carbonaceous material with the curvature can be urged to be produced in accordance with the catalytic action of these metals or the alloy thereof. It has been known that these metals or the alloys thereof perform a catalytic action when the carbonaceous material such as fullerene, carbon nanofiber, carbon nanotube and carbon fiber or the like is produced by a laser ablation method. The carbonaceous material such as fullerene, carbon nanofiber, carbon nanotube and carbon fiber or the like may be collected, added to and mixed with the hydrogen-storing carbonaceous material so that the surface of the hydrogen-storing carbonaceous material includes these metals or the alloys thereof.

Further, in the present invention, the carbonaceous material including these metals or alloys thereof or the carbonaceous material including no metal or no alloy carries at least on its surface metallic fine particles of 10 wt % or less which have a catalyzing function for separating hydrogen atoms from hydrogen molecules, and further, separating protons and electrons from the hydrogen atoms. As a preferable metal having such a catalyzing function, there may be exemplified platinum or a platinum alloy, etc. In order to carry these metals on the surface of the carbonaceous material, a well-known method such as a sputtering method, a vacuum deposition method, a chemical method, a mixture or the like may be used.

Further, when platinum fine particles or platinum alloy fine particles are carried on the carbonaceous material, a chemically carrying method using solution containing platinum complexes or an arc discharge method using electrodes including platinum may be applied thereto. In the chemically carrying method, for instance, chloroplatinic acid solution is treated with sodium hydrogen sulfite or hydrogen peroxide, then, the carbonaceous material is added to the resultant solution and the solution is agitated so that the platinum fine particles or the platinum alloy fine particles can be carried on the carbonaceous materials. On the other hand, in the arc discharge method, the platinum or the platinum alloy is partly attached to the electrode part of the arc discharge, and is subjected to the arc discharge to be evaporated so that the platinum or the platinum alloy can be adhered to the carbonaceous material housed in a chamber.

The above described metals or the alloys thereof are carried on the carbonaceous material, so that the hydrogen storage capacity can be more improved than that when the metals or the alloys thereof are not carried on the carbonaceous material. Further, it is found that an fluorine serving as an electron donor or an amine molecule such as ammonia is mixed or combined with the carbonaceous material to efficiently generate a charge separation.

As described above, hydrogen composed of protons and electrons is supplied to the hydrogen-storing carbonaceous material as a strong electron acceptor on which the above mentioned metals or the alloys are mounted, hence the hydrogen is stored in the form of protons. Therefore, its occupied volume is greatly reduced and a large amount of hydrogen can be stored in the hydrogen-storing carbonaceous material as compared with the storage by the conventional chemisorption of hydrogen atoms. That is, the hydrogen is separated into electrons and protons from the state of atoms, and the electrons are efficiently stored in the hydrogen-storing carbonaceous material so that a large amount of high density hydrogen can be finally stored in the state of protons. Accordingly, when the above described metals or the alloys are carried on the surface of the hydrogen-storing carbonaceous material, the hydrogen can be more efficiently stored and a larger amount of hydrogen can be stored. The above described hydrogen-storing carbonaceous material is light, easily transported, can be repeatedly employed at around room temperature without generating a structural destruction and can be safely handled. Further, the amount of use of a metallic catalyst such as platinum can be reduced. The carbonaceous material such as fullerene serving as a starting material can be also produced at a low cost. Further, there can be realized an excellent practicability that a problem is not found in view of the procurement of resources nor a problem such as an environmental destruction is generated during a use.

Still further objects and specific advantages obtained by the present invention will become more apparent from the description of embodiments or examples explained hereinafter.

### BRIEF DESCRIPTION OF THE DRAWINGS

FIG. 1 is a diagram showing a schematic structure of a fuel cell according to the present invention.

FIG. 2 is a diagram showing a schematic structure of an alkaline storage battery (secondary battery) to which the present invention is applied.

FIG. 3 is a graph showing the cyclic characteristics of the alkaline storage battery according to the present invention.

FIG. 4 is a diagram showing a schematic structure of a hydrogen-air fuel cell according to the present invention.

FIG. 5 is a graph showing the discharge characteristics of the hydrogen-air fuel cell according to the present invention.

### BEST MODE FOR CARRYING OUT THE INVENTION

Now, the specific configurations of a fuel cell and a secondary battery using a carbonaceous material according to the present invention will be described by referring to the accompanying drawings.

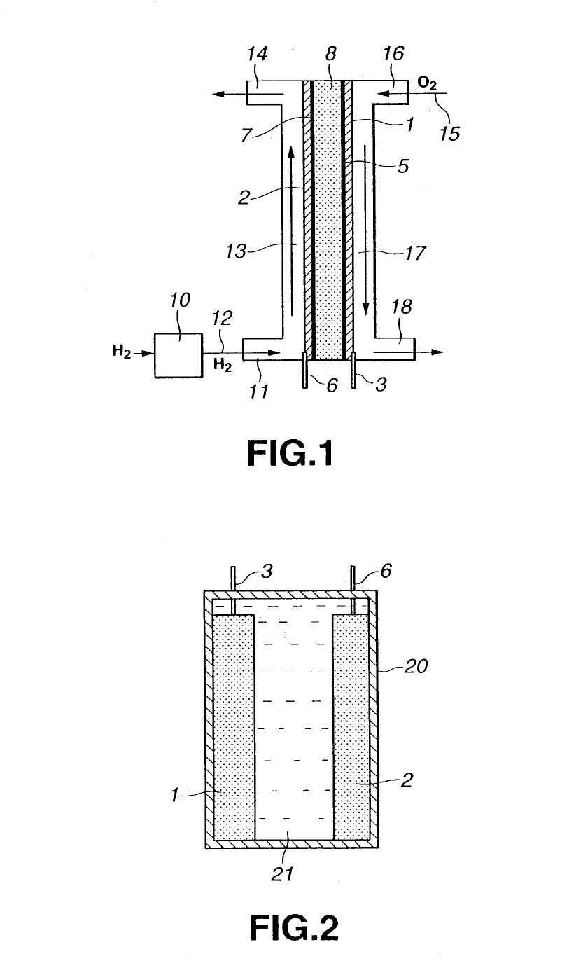

The fuel cell according to the present invention is provided with a cathode 1 and an anode 2 arranged so as to be opposed to each other as shown in FIG. 1. Here, as the cathode 1, an oxygen electrode is used. As the anode 2, a fuel electrode or a hydrogen electrode is used. The cathode 1 has a cathode lead 3 and a catalyst 5 is dispersed in the cathode or is adhered to the cathode. The anode 2 also has an anode lead 6 and a catalyst 7 is dispersed in the anode or is adhered to the anode. A proton conductor 8 is sandwiched in between the cathode 1 and the anode 2. Hydrogen 12 as fuel is supplied to a passage 13 in the side of the anode 2 through an introducing port 11 from a hydrogen supply source 10, and discharged from a discharge port 14. In the side of the cathode 1, air 15 is supplied to a passage 17 from an introducing port 16 and discharged from a discharge port 18.

While the hydrogen 12 serving as the fuel supplied to the passage 13 from the introducing port 11 passes the passage 13, protons are generated and the generated protons move to the side of the cathode 1 together with protons generated in the proton conductor 8. As a result, the protons react with oxygen in the air 15 supplied to the passage 17 from the introducing port 16 and directed to the discharge port 18 so that a desired electromotive force is taken out.

In the present invention, for the hydrogen supply source 10, is employed a hydrogen-stored carbonaceous material obtained by heating a carbonaceous material such as fullerene, carbon nanofiber, carbon nanotube, carbon soot, nanocapsule, bucky onion and carbon fiber or the like at from 200° C. to 900° C. under the atmosphere of nitrogen gas and then storing hydrogen under the pressure of hydrogen of lower than 10 atmospheric pressure.

In the fuel cell according to the present invention, since, while the protons are dissociated, the protons supplied from the anode 2 side move to the cathode 1 side in the proton conductor 8, the conductivity of the protons is characteristically improved. Therefore, since a humidifier which has been hitherto required for conducting protons is not needed, a system can be simplified and lightened.

For more clearly describing the effects of the present invention, examples and comparative examples of the present invention will be mentioned below.

### EXAMPLE 1

A carbon nanofiber with one nanotube fiber whose diameter is about 200 nm was manufactured by a CVD method and impurities such as a catalyst were completely removed until purity became 95% or higher before a thermobalance measurement was carried out.

The carbon nanofiber of 14.3 mg thus obtained was accommodated in a sample cup in a thermobalance and the sample cup including the carbon nanofiber was set in a thermogravimetry apparatus so that the contents of the thermogravimetry vessel were completely replaced by using nitrogen gas.

Then, the carbon nanofiber was heated at 100° C. for 6 hours in the atmosphere of nitrogen gas under 1 atmospheric pressure to prepare a hydrogen-storing carbonaceous material #1.

Subsequently, hydrogen gas of 1 atmospheric pressure was introduced into the thermogravimetry vessel to measure the change of the mass of the hydrogen-storing carbonaceous material #1.

As a consequence, it was found that the amount of stored hydrogen was 0.3 wt % from the increase of the mass. Here, the amount of stored hydrogen is a value obtained by dividing the mass of stored hydrogen by the mass of carbon.

When the carbon nanofiber was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that when the heating process was carried out in the atmosphere of nitrogen gas was obtained.

### EXAMPLE 2

A carbon nanofiber of 14.3 mg manufactured and treated in the same manner as that of the Example 1 was accommodated in a sample cup in a thermobalance and the sample cup including the carbon nanofiber was set in a thermogravimetry apparatus so that the contents of the thermogravimetry vessel were completely replaced by using nitrogen gas.

Then, the carbon nanofiber was heated at 200° C. for 6 hours in the atmosphere of nitrogen gas to prepare a hydrogen-storing carbonaceous material #2.

Subsequently, hydrogen gas of 1 atmospheric pressure was introduced into the thermogravimetry vessel to measure the change of the mass of the hydrogen-storing carbonaceous material #2.

As a consequence, it was found that the amount of stored hydrogen was 1.4 wt % from the increase of the mass. Here, the amount of stored hydrogen is a value obtained by dividing the mass of stored hydrogen by the mass of carbon.

When the carbon nanofiber was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that obtained when the heating process was carried out in the atmosphere of nitrogen gas was obtained.

### EXAMPLE 3

A carbon nanofiber of 14.3 mg manufactured and treated in the same manner as that of the Example 1 was accommodated in a sample cup in a thermobalance and the sample cup including the carbon nanofiber was set in a thermogravimetry apparatus so that the contents of the thermogravimetry vessel were completely replaced by using nitrogen gas.

Then, the carbon nanofiber was heated at 400° C. for 6 hours in the atmosphere of nitrogen gas to prepare a hydrogen-storing carbonaceous material #3.

Subsequently, hydrogen gas of 1 atmospheric pressure was introduced into the thermogravimetry vessel to measure the change of the mass of the hydrogen-storing carbonaceous material #3.

As a consequence, it was found that the amount of stored hydrogen was 2.7 wt % from the increase of the mass. Here, the amount of stored hydrogen is a value obtained by dividing the mass of stored hydrogen by the mass of carbon.

When the carbon nanofiber was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that obtained when the heating process was carried out in the atmosphere of nitrogen gas was

### EXAMPLE 4

A carbon nanofiber of 14.3 mg manufactured and treated in the same manner as that of the Example 1 was accommodated in a sample cup in a thermobalance and the sample cup including the carbon nanofiber was set in a thermogravimetry apparatus so that the contents of the thermogravimetry vessel were completely replaced by using nitrogen gas.

Then, the carbon nanofiber was heated at 600° C. for 6 hours in the atmosphere of nitrogen gas to prepare a hydrogen-storing carbonaceous material #4.

Subsequently, hydrogen gas of 1 atmospheric pressure was introduced into the thermogravimetry vessel to measure the change of the mass of the hydrogen-storing carbonaceous material #4.

As a consequence, it was found that the amount of stored hydrogen was 5.4 wt % from the increase of the mass. Here, the amount of stored hydrogen is a value obtained by dividing the mass of stored hydrogen by the mass of carbon.

When the carbon nanofiber was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that obtained when the heating process was carried out in the atmosphere of nitrogen gas was obtained.

### EXAMPLE 5

A carbon nanofiber of 14.3 mg manufactured and treated in the same manner as that of the Example 1 was accommodated in a sample cup in a thermobalance and the sample cup including the carbon nanofiber was set in a thermogravimetry apparatus so that the contents of the thermogravimetry vessel were completely replaced by using nitrogen gas.

Then, the carbon nanofiber was heated at 800° C. for 6 hours in the atmosphere of nitrogen gas to prepare a hydrogen-storing carbonaceous material #5.

Subsequently, hydrogen gas of 1 atmospheric pressure was introduced into the thermogravimetry vessel to measure the change of the mass of the hydrogen-storing carbonaceous material #5.

As a consequence, it was found that the amount of stored hydrogen was 14.7 wt % from the increase of the mass. Here, the amount of stored hydrogen is a value obtained by dividing the mass of stored hydrogen by the mass of carbon.

When the carbon nanofiber was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that obtained when the heating process was carried out in the atmosphere of nitrogen gas was obtained.

### EXAMPLE 6

A carbon nanofiber of 14.3 mg manufactured and treated in the same manner as that of the Example 1 was accommodated in a sample cup in a thermobalance and the sample cup including the carbon nanofiber was set in a thermogravimetry apparatus so that the contents of the thermogravimetry vessel were completely replaced by using nitrogen gas.

Then, the carbon nanofiber was heated at 1000° C. for 6 hours in the atmosphere of nitrogen gas to prepare a hydrogen-storing carbonaceous material #6.

Subsequently, hydrogen gas of 1 atmospheric pressure was introduced into the thermogravimetry vessel to measure the change of the mass of the hydrogen-storing carbonaceous material #6.

As a consequence, it was found that the amount of stored hydrogen was 11.6 wt % from the increase of the mass. Here, the amount of stored hydrogen is a value obtained by dividing the mass of stored hydrogen by the mass of carbon.

When the carbon nanofiber was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that obtained when the heating process was carried out in the atmosphere of nitrogen gas was obtained.

### EXAMPLE 7

A carbon nanofiber of 14.3 mg manufactured and treated in the same manner as that of the Example 1 was accommodated in a sample cup in a thermobalance and the sample cup including the carbon nanofiber was set in a thermogravimetry apparatus so that the contents of the thermogravimetry vessel were completely replaced by using nitrogen gas.

Then, the carbon nanofiber was heated at 1200° C. for 6 hours in the atmosphere of nitrogen gas to prepare a hydrogen-storing carbonaceous material #7.

Subsequently, hydrogen gas of 1 atmospheric pressure was introduced into the thermogravimetry vessel to measure the change of the mass of the hydrogen-storing carbonaceous material #7.

As a consequence, it was found that the amount of stored hydrogen was 5.2 wt % from the increase of the mass. Here, the amount of stored hydrogen is a value obtained by dividing the mass of stored hydrogen by the mass of carbon.

When the carbon nanofiber was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that obtained when the heating process was carried out in the atmosphere of nitrogen gas was obtained.

### EXAMPLE 8

A carbon nanofiber of 14.3 mg manufactured and treated in the same manner as that of the Example 1 was accommodated in a sample cup in a thermobalance and the sample cup including the carbon nanofiber was set in a thermogravimetry apparatus so that the contents of the thermogravimetry vessel were completely replaced by using nitrogen gas.

Then, the carbon nanofiber was heated at 1400° C. for 6 hours in the atmosphere of nitrogen gas to prepare a hydrogen-storing carbonaceous material #8.

Subsequently, hydrogen gas of 1 atmospheric pressure was introduced into the thermogravimetry vessel to measure the change of the mass of the hydrogen-storing carbonaceous material #8.

As a consequence, it was found that the amount of stored hydrogen was 0.3 wt % from the increase of the mass. Here, the amount of stored hydrogen is a value obtained by dividing the mass of stored hydrogen by the mass of carbon.

When the carbon nanofiber was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that obtained when the heating process was carried out in the atmosphere of nitrogen gas was obtained.

### EXAMPLE 9

A carbon nanotube with one carbon nanotube whose diameter is about 200 nm was manufactured by a CVD method and impurities such as a catalyst were completely removed until purity became 95% or higher before a thermobalance measurement was carried out.

The carbon nanotube of 14.3 mg thus obtained was accommodated in a sample cup in a thermobalance and the sample cup including the carbon nanotube was set in a thermogravimetry apparatus so that the contents of the thermogravimetry vessel were completely replaced by using nitrogen gas.

Then, the carbon nanotube was heated at 100° C. for 6 hours in the atmosphere of nitrogen gas to prepare a hydrogen-storing carbonaceous material #9.

Subsequently, hydrogen gas of 1 atmospheric pressure was introduced into the thermogravimetry vessel to measure the change of the mass of the hydrogen-storing carbonaceous material #9.

As a consequence, it was found that the amount of stored hydrogen was 0.2 wt % from the increase of the mass. Here, the amount of stored hydrogen is a value obtained by dividing the mass of stored hydrogen by the mass of carbon.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that when the heating process was carried out in the atmosphere of nitrogen gas was obtained.

### EXAMPLE 10

A carbon nanotube of 14.3 mg manufactured and treated in the same manner as that of the Example 9 was accommodated in a sample cup in a thermobalance and the sample cup including the carbon nanotube was set in a thermogravimetry apparatus so that the contents of the thermogravimetry vessel were completely replaced by using nitrogen gas.

Then, the carbon nanotube was heated at 200° C. for 6 hours in the atmosphere of nitrogen gas to prepare a hydrogen-storing carbonaceous material #10.

Subsequently, hydrogen gas of 1 atmospheric pressure was introduced into the thermogravimetry vessel to measure the change of the mass of the hydrogen-storing carbonaceous material #8.

As a consequence, it was found that the amount of stored hydrogen was 1.2 wt % from the increase of the mass. Here, the amount of stored hydrogen is a value obtained by dividing the mass of stored hydrogen by the mass of carbon.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that obtained when the heating process was carried out in the atmosphere of nitrogen gas was obtained.

### EXAMPLE 11

A carbon nanotube of 14.3 mg manufactured and treated in the same manner as that of the Example 9 was accommodated in a sample cup in a thermobalance and the sample cup including the carbon nanotube was set in a thermogravimetry apparatus so that the contents of the thermogravimetry vessel were completely replaced by using nitrogen gas.

Then, the carbon nanotube was heated at 400° C. for 6 hours in the atmosphere of nitrogen gas to prepare a hydrogen-storing carbonaceous material #11.

Subsequently, hydrogen gas of 1 atmospheric pressure was introduced into the thermogravimetry vessel to measure the change of the mass of the hydrogen-storing carbonaceous material #11.

As a consequence, it was found that the amount of stored hydrogen was 2.2 wt % from the increase of the mass. Here, the amount of stored hydrogen is a value obtained by dividing the mass of stored hydrogen by the mass of carbon.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that obtained when the heating process was carried out in the atmosphere of nitrogen gas was obtained.

### EXAMPLE 12

A carbon nanotube of 14.3 mg manufactured and treated in the same manner as that of the Example 9 was accommodated in a sample cup in a thermobalance and the sample cup including the carbon nanotube was set in a thermogravimetry apparatus so that the contents of the thermogravimetry vessel were completely replaced by using nitrogen gas.

Then, the carbon nanotube was heated at 600° C. for 6 hours in the atmosphere of nitrogen gas to prepare a hydrogen-storing carbonaceous material #12.

Subsequently, hydrogen gas of 1 atmospheric pressure was introduced into the thermogravimetry vessel to measure the change of the mass of the hydrogen-storing material #12

As a consequence, it was found that the amount of stored hydrogen was 4.4 wt % from the increase of the mass. Here, the amount of stored hydrogen is a value obtained by dividing the mass of stored hydrogen by the mass of carbon.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that obtained when the heating process was carried out in the atmosphere of nitrogen gas was obtained.

### EXAMPLE 13

A carbon nanotube of 14.3 mg manufactured and treated in the same manner as that of the Example 9 was accommodated in a sample cup in a thermobalance and the sample cup including the carbon nanotube was set in a thermogravimetry apparatus so that the contents of the thermogravimetry vessel were completely replaced by using nitrogen gas.

Then, the carbon nanotube was heated at 800° C. for 6 hours in the atmosphere of nitrogen gas to prepare a hydrogen-storing carbonaceous material #13.

Subsequently, hydrogen gas of 1 atmospheric pressure was introduced into the thermogravimetry vessel to measure the change of the mass of the hydrogen-storing carbonaceous material #13.

As a consequence, it was found that the amount of stored hydrogen was 10.7 wt % from the increase of the mass. Here, the amount of stored hydrogen is a value obtained by dividing the mass of stored hydrogen by the mass of carbon.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that obtained when the heating process was carried out in the atmosphere of nitrogen gas was obtained.

### EXAMPLE 14

A carbon nanotube of 14.3 mg manufactured and treated in the same manner as that of the Example 9 was accommodated in a sample cup in a thermobalance and the sample cup including the carbon nanotube was set in a thermogravimetry apparatus so that the contents of the thermogravimetry vessel were completely replaced by using nitrogen gas.

Then, the carbon nanotube was heated at 1000° C. for 6 hours in the atmosphere of nitrogen gas to prepare a hydrogen-storing carbonaceous material #14.

Subsequently, hydrogen gas of 1 atmospheric pressure was introduced into the thermogravimetry vessel to measure the change of the mass of the hydrogen-storing carbonaceous material #14.

As a consequence, it was found that the amount of stored hydrogen was 8.6 wt % from the increase of the mass. Here, the amount of stored hydrogen is a value obtained by dividing the mass of stored hydrogen by the mass of carbon.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that obtained when the heating process was carried out in the atmosphere of nitrogen gas was obtained.

### EXAMPLE 15

A carbon nanotube of 14.3 mg manufactured and treated in the same manner as that of the Example 9 was accommodated in a sample cup in a thermobalance and the sample cup including the carbon nanotube was set in a thermogravimetry apparatus so that the contents of the thermogravimetry vessel were completely replaced by using nitrogen gas.

Then, the carbon nanotube was heated at 1200° C. for 6 hours in the atmosphere of nitrogen gas to prepare a hydrogen-storing carbonaceous material #15.

Subsequently, hydrogen gas of 1 atmospheric pressure was introduced into the thermogravimetry vessel to measure the change of the mass of the hydrogen-storing carbonaceous material #15.

As a consequence, it was found that the amount of stored hydrogen was 2.2 wt % from the increase of the mass. Here, the amount of stored hydrogen is a value obtained by dividing the mass of stored hydrogen by the mass of carbon.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that obtained when the heating process was carried out in the atmosphere of nitrogen gas was obtained.

### EXAMPLE 16

A carbon nanotube of 14.3 mg manufactured and treated in the same manner as that of the Example 9 was accommodated in a sample cup in a thermobalance and the sample cup including the carbon nanofiber was set in a thermogravimetry apparatus so that the contents of the thermogravimetry vessel were completely replaced by using nitrogen gas.

Then, the carbon nanotube was heated at 1400° C. for 6 hours in the atmosphere of nitrogen gas to prepare a hydrogen-storing carbonaceous material #16.

Subsequently, hydrogen gas of 1 atmospheric pressure was introduced into the thermogravimetry vessel to measure the change of the mass of the hydrogen-storing carbonaceous material #16.

As a consequence, it was found that the amount of stored hydrogen was 0.2 wt % from the increase of the mass. Here, the amount of stored hydrogen is a value obtained by dividing the mass of stored hydrogen by the mass of carbon.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that obtained when the heating process was carried out in the atmosphere of nitrogen gas was obtained.

### COMPARATIVE EXAMPLE 1

A carbon nanofiber of 14.3 mg manufactured and treated in the same manner as that of the Example 1 was accommodated in a sample cup in a thermobalance and the sample cup including the carbon nanofiber was set in a thermogravimetry apparatus so that the contents of the thermogravimetry vessel were completely replaced by using nitrogen gas.

Then, the carbon nanofiber was heated at 25° C. for 6 hours in the atmosphere of nitrogen gas to prepare a hydrogen-storing carbonaceous material #21.

Subsequently, hydrogen gas of 1 atmospheric pressure was introduced into the thermogravimetry vessel to measure the change of the mass of the hydrogen-storing carbonaceous material #21.

As a consequence, it was found that the amount of stored hydrogen was 0 wt % from the change of the mass. Here, the amount of stored hydrogen is a value obtained by dividing the mass of stored hydrogen by the mass of carbon.

When the carbon nanofiber was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that obtained when the heating process was carried out in the atmosphere of nitrogen gas was obtained.

### COMPARATIVE EXAMPLE 2

A carbon nanotube of 14.3 mg manufactured and treated in the same manner as that of the Example 9 was accommodated in a sample cup in a thermobalance and the sample cup including the carbon nanotube was set in a thermogravimetry apparatus so that the contents of the thermogravimetry vessel were completely replaced by using nitrogen gas.

Then, the carbon nanotube was heated at 25° C. for 6 hours in the atmosphere of nitrogen gas to prepare a hydrogen-storing carbonaceous material #22.

Subsequently, hydrogen gas of 1 atmospheric pressure was introduced into the thermogravimetry vessel to measure the change of the mass of the hydrogen-storing carbonaceous material #22.

As a consequence, it was found that the amount of stored hydrogen was 0 wt % from the change of the mass. Here, the amount of stored hydrogen is a value obtained by dividing the mass of stored hydrogen by the mass of carbon.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that obtained when the carbon nanotube was heated in the atmosphere of nitrogen gas was obtained.

### COMPARATIVE EXAMPLE 3

A carbon nanofiber with one nanotube fiber whose diameter is about 200 nm was manufactured by a CVD method and impurities such as a catalyst were completely removed until purity became 95% or higher before a thermobalance measurement was carried out, so that a hydrogen-storing carbonaceous material #23 was obtained.

The hydrogen-storing carbonaceous material #23 of 14.3 mg thus obtained was accommodated in a sample cup in a thermobalance and the sample cup including the hydrogen-storing carbonaceous material was set in a thermogravimetry apparatus so that the contents of the thermogravimetry vessel were completely replaced by using nitrogen gas.

Subsequently, hydrogen gas of 1 atmospheric pressure was introduced into the thermogravimetry vessel to measure the change of the mass of the hydrogen-storing carbonaceous material #23.

As a consequence, it was found that the amount of stored hydrogen was 0 wt % from the change of the mass. Here, the amount of stored hydrogen is a value obtained by dividing the mass of stored hydrogen by the mass of carbon.

When the carbon nanofiber was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that when the heating process was carried out in the atmosphere of nitrogen gas was obtained.

### COMPARATIVE EXAMPLE 4

A carbon nanotube was manufactured in the same manner as that of the Example 9 and impurities were removed to obtain a hydrogen-storing carbonaceous material #24.

The hydrogen-storing carbonaceous material #24 of 14.3 mg thus obtained was accommodated in a sample cup in a thermobalance and the sample cup including the hydrogen-storing carbonaceous material was set in a thermogravimetry apparatus so that the contents of the thermogravimetry vessel were completely replaced by using nitrogen gas.

Subsequently, hydrogen gas of 1 atmospheric pressure was introduced into the thermogravimetry vessel to measure the change of the mass of the hydrogen-storing carbonaceous material #24.

As a consequence, it was found that the amount of stored hydrogen was 0 wt % from the change of the mass. Here, the amount of stored hydrogen is a value obtained by dividing the mass of stored hydrogen by the mass of carbon.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the absolutely same manner, the same result as that obtained when the heating process was carried out in the atmosphere of nitrogen gas was obtained.

As understood from the above described Examples and Comparative Examples, the hydrogen-storing carbonaceous materials #1 to #16 according to the Examples of the present invention which were obtained by heating the carbon nanofibers and carbon nanotubes at more than 100° C. under the atmosphere of inert gas exhibited a hydrogen storage capacity when they were placed under hydrogen gas of 1 atmospheric pressure. On the other hand, however, the hydrogen-storing carbonaceous materials #21 and #22 according to the Comparative Examples 1 and 2 which were obtained by heating the carbon nanofiber and the carbon nanotube at lower than 100° C. did not exhibit the hydrogen storage capacity when they were placed under the hydrogen gas of 1 atmospheric pressure. Further, it was found that the hydrogen-storing carbonaceous materials #23 and #24 according to the Comparative Examples 3 and 4 which employed the carbon nanofiber and the carbon nanotube whose heating process was not carried out as the hydrogen-storing carbonaceous material did not exhibit the hydrogen storage capacity when they were placed under the hydrogen gas of 1 atmospheric pressure.

Therefore, it was understood that, when the hydrogen was stored under the pressure of hydrogen of 1 atmospheric pressure, the carbon nanofiber and the carbon nanotube were preferably heated at more than 100° C. under the atmosphere of inert gas to prepare the hydrogen-storing carbonaceous material.

### EXAMPLE 17

A hydrogen-storing carbonaceous material #9 was prepared in the same manner as that of the Example 9, hydrogen gas of 9.8 atmospheric pressure was introduced into a thermogravimetry vessel and held for 6 hours.

After that, when the thermogravimetry vessel was opened to atmosphere to obtain the amount of stored hydrogen by using an integrating flowmeter, it was recognized that the amount of stored hydrogen was 0.7 wt %.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the completely same manner, the same result as that obtained when the carbon nanotube was heated in the atmosphere of nitrogen gas was obtained.

### EXAMPLE 18

A hydrogen-storing carbonaceous material #10 was prepared in the same manner as that of the Example 10, hydrogen gas of 9.8 atmospheric pressure was introduced into a thermogravimetry vessel and held for 6 hours.

After that, when the thermogravimetry vessel was opened to atmosphere to obtain the amount of stored hydrogen by using an integrating flowmeter, it was recognized that the amount of stored hydrogen was 2.5 wt %.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the completely same manner, the same result as that obtained when the carbon nanotube was heated in the atmosphere of nitrogen gas was obtained.

### EXAMPLE 19

A hydrogen-storing carbonaceous material #11 was prepared in the same manner as that of the Example 11, hydrogen gas of 9.8 atmospheric pressure was introduced into a thermogravimetry vessel and held for 6 hours.

After that, when the thermogravimetry vessel was opened to atmosphere to obtain the amount of stored hydrogen by using an integrating flowmeter, it was recognized that the amount of stored hydrogen was 3.3 wt %.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the completely same manner, the same result as that obtained when the carbon nanotube was heated in the atmosphere of nitrogen gas was obtained.

### EXAMPLE 20

A hydrogen-storing carbonaceous material #12 was prepared in the same manner as that of the Example 12, hydrogen gas of 9.8 atmospheric pressure was introduced into a thermogravimetry vessel and held for 6 hours.

After that, when the thermogravimetry vessel was opened to atmosphere to obtain the amount of stored hydrogen by using an integrating flowmeter, it was recognized that the amount of stored hydrogen was 6.8 wt %.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the completely same manner, the same result as that obtained when the carbon nanotube was heated in the atmosphere of nitrogen gas was obtained.

### EXAMPLE 21

A hydrogen-storing carbonaceous material #13 was prepared in the same manner as that of the Example 13, hydrogen gas of 9.8 atmospheric pressure was introduced into a thermogravimetry vessel and held for 6 hours.

After that, when the thermogravimetry vessel was opened to atmosphere to obtain the amount of stored hydrogen by using an integrating flowmeter, it was recognized that the amount of stored hydrogen was 18.4 wt %.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the completely same manner, the same result as that obtained when the carbon nanotube was heated in the atmosphere of nitrogen gas was obtained.

### EXAMPLE 22

A hydrogen-storing carbonaceous material #14 was prepared in the same manner as that of the Example 14, hydrogen gas of 9.8 atmospheric pressure was introduced into a thermogravimetry vessel and held for 6 hours.

After that, when the thermogravimetry vessel was opened to atmosphere to obtain the amount of stored hydrogen by using an integrating flowmeter, it was recognized that the amount of stored hydrogen was 17.5 wt %.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the completely same manner, the same result as that obtained when the carbon nanotube was heated in the atmosphere of nitrogen gas was obtained.

### EXAMPLE 23

A hydrogen-storing carbonaceous material #15 was prepared in the same manner as that of the Example 15, hydrogen gas of 9.8 atmospheric pressure was introduced into a thermogravimetry vessel and held for 6 hours.

After that, when the thermogravimetry vessel was opened to atmosphere to obtain the amount of stored hydrogen by using an integrating flowmeter, it was recognized that the amount of stored hydrogen was 6.7 wt %.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the completely same manner, the same result as that obtained when the carbon nanotube was heated in the atmosphere of nitrogen gas was obtained.

### EXAMPLE 24

A hydrogen-storing carbonaceous material #16 was prepared in the same manner as that of the Example 16, hydrogen gas of 9.8 atmospheric pressure was introduced into a thermogravimetry vessel and held for 6 hours.

After that, when the thermogravimetry vessel was opened to atmosphere to obtain the amount of stored hydrogen by using an integrating flowmeter, it was recognized that the amount of stored hydrogen was 0.5 wt %.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the completely same manner, the same result as that obtained when the carbon nanotube was heated in the atmosphere of nitrogen gas was obtained.

### COMPARATIVE EXAMPLE 5

A hydrogen-storing carbonaceous material #22 was prepared in the same manner as that of the Comparative Example 2, hydrogen gas of 9.8 atmospheric pressure was introduced into a thermogravimetry vessel and held for 6 hours.

After that, when the thermogravimetry vessel was opened to atmosphere to obtain the amount of stored hydrogen by using an integrating flowmeter, it was recognized that the amount of stored hydrogen was 0 wt %.

When the carbon nanotube was heated respectively in the atmosphere of helium gas, in the atmosphere of argon gas, and in the atmosphere of xenon gas in place of the atmosphere of nitrogen gas to measure the amount of stored hydrogen in the completely same manner, the same result as that obtained when the carbon nanotube was heated in the atmosphere of nitrogen gas was obtained.

As understood from the Examples 17 to 24 and the Comparative Example 5, when the hydrogen was stored under the atmospheric pressure of 9.8, the hydrogen-storing carbonaceous materials #9 to #16 according to the Examples of the present invention which were obtained by heating the carbon nanotubes at more than 100° C. under the atmosphere of inert gas exhibited a hydrogen storage capacity. However, the hydrogen-storing carbonaceous material #22 according to the Comparative Example 5 which was obtained by heating the carbon nanotube at lower than 100° C. did not exhibited a hydrogen storage capacity. Also when the hydrogen was stored under the pressure of hydrogen of 9.8 atmospheric pressure, it was recognized that the carbon nanofiber and the carbon nanotube were preferably subjected to a heating process at more than 100° C. under the atmosphere of inert gas.

### EXAMPLE 25

An alkaline storage battery was manufactured in the following manner.

<Manufacture of Cathode>

Carboxymethyl cellulose of 3 wt % was added to spherical nickel hydroxide of 10 g with the average particle size of 30 μm and cobalt hydroxide of 1 g and the mixture was kneaded with water to prepare paste. A porous nickel foam with the porosity of 95% was filled with the paste, and the porous nickel foam filled with the paste was dried and pressed, and then punched to manufacture a cathode having the diameter of 20 mm and the thickness of 0.7 mm.

<Manufacture of Anode >

The hydrogen-storing carbonaceous material #13 was prepared in accordance with the Example 13. Carboxymethyl cellulose of 5% and water were added to the hydrogen-stored carbonaceous material which stored hydrogen in accordance with the Example 21 to prepare kneaded paste. The porous nickel foam with the porosity of 95% was filled with the paste, the porous nickel foam filled with the paste was dried and pressed, and then punched to manufacture an anode with the diameter of 20 mm and the thickness of 0.5 mm.

<Alkaline Storage Battery>

Then, an alkaline storage battery (secondary battery) schematically shown in FIG. 2 was manufactured by using the cathode and the anode manufactured as described above and potassium hydroxide solution of 7N as electrolyte solution.

The alkaline storage battery comprises a cathode 1, an anode 2 and electrolyte solution 21 contained therebetween in a battery vessel 20. A cathode lead 3 and an anode lead 6 are taken outside the battery vessel 20 from the respective electrodes.

<Charge and Discharge Performance>

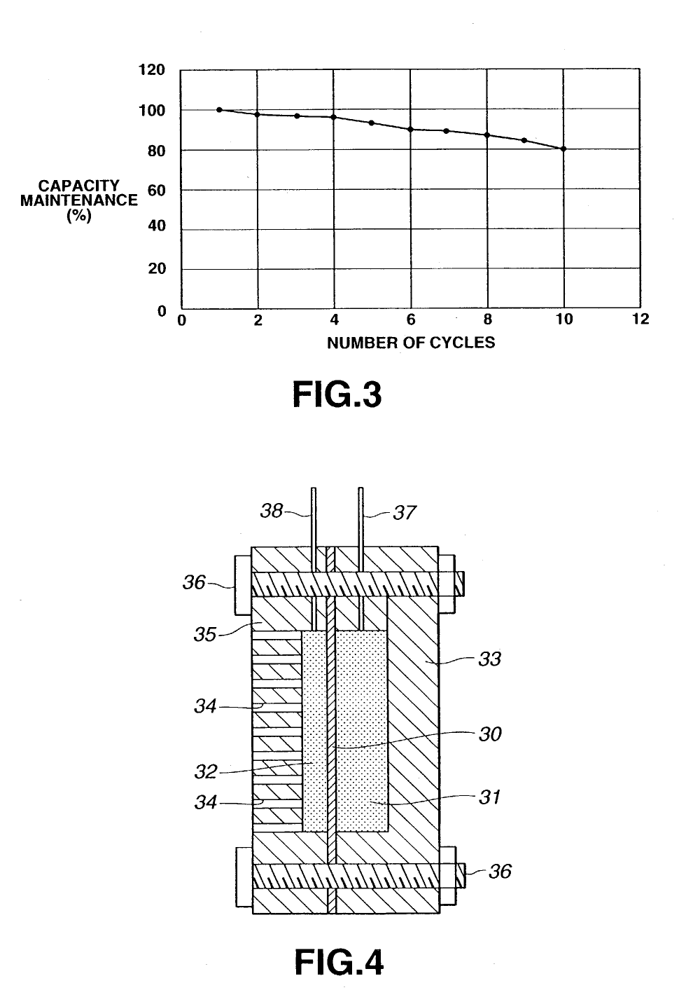

For the alkaline storage battery manufactured as described above, the charge and discharge test was carried out with 0.1C, the upper limit of 1.4V and the lower limit of 0.8V. The cyclic characteristics at that time are shown in FIG. 3.

As apparent from FIG. 3, although it could not be said that a cycle life was not sufficient from the viewpoint of structure of the battery, a basic charge and discharge performance could be recognized.

### EXAMPLE 26

A hydrogen-air fuel cell was manufactured in the following manner.

<Manufacture of Air Electrode>

The hydrogen-storing carbonaceous material #13 was prepared in accordance with the Example 13 and hydrogen was stored in accordance with the Example 21 to obtain the hydrogen-stored carbonaceous material. The hydrogen-stored carbonaceous material and polymer electrolyte alcoholic solution composed of perfluorosulfonic acid were dispersed in n-butyl acetate to prepare catalyst layer slurry.

On the other hand, a carbon nonwoven fabric with the thickness of 250 μm was immersed in the emulsion of fluorine water repellent, dried and then heated at 400° C., so that the carbon nonwoven fabric was subjected to a water repellent process. Subsequently, the carbon nonwoven fabric was cut to the size of 4 cm×4 cm and the catalyst layer slurry prepared as described above was applied to one surface thereof.

<Adhesion of Air Electrode to Polymer Electrolyte Film>

A polymer electrolyte film composed of perfluorosulfonic acid with the thickness of 50 μm was adhered to the surface of the carbon nonwoven fabric to which the catalyst layer was applied, and then, the film adhered to the nonwoven fabric was dried.

<Manufacture of Hydrogen Electrode>

Carboxymethyl cellulose of 5% and water were added to the same hydrogen-stored carbonaceous material as that used for manufacturing the air electrode to prepare paste. A porous nickel foam with the porosity of 95% was filled with the paste, dried and pressed and the dried and pressed porous nickel foam was cut to the size of 4 cm×4 cm to manufacture a hydrogen electrode with the thickness of 0.5 mm.

<Manufacture of Hydrogen-Air Fuel Cell>

The hydrogen electrode was superposed on the adhered body of the air electrode and the perfluorosulfonic acid polymer electrolyte film obtained as described above by holding the polymer electrolyte film therebetween. Both the surfaces thereof were firmly held by Teflon plates with the thickness of 3 mm and fixed by bolts. Many holes with diameter of 1.5 mm are previously opened on the Teflon plate arranged in the air electrode side so that air can be smoothly supplied to an electrode.

The schematic structure of the hydrogen-air fuel cell thus assembled is shown in FIG. 4.

As shown in FIG. 4, in the hydrogen-air fuel cell thus manufactured, a hydrogen electrode 31 and an air electrode 32 are arranged so as to be opposed to each other by locating a polymer electrolyte film 30 between the hydrogen electrode and the air electrode. The outer side of these members is held by a Teflon plate 33 and a Teflon plate 35 provided with many air holes 34 and all the body is fixed by means of bolts 36 and 36. A hydrogen electrode lead 37 and an air electrode lead 38 are respectively taken out from the respective electrodes.

<Discharge Characteristics of Hydrogen-Air Fuel Cell>

Then, the discharge characteristics of the hydrogen-air fuel cell was examined.

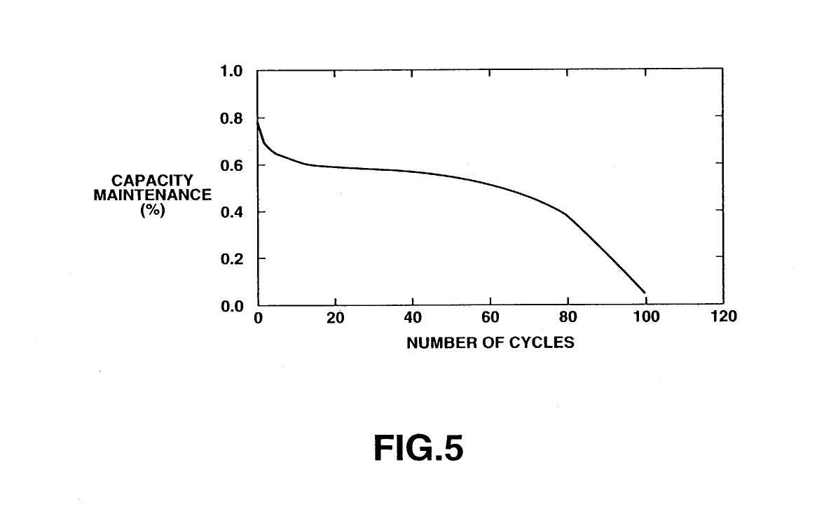

Initially, electric current was supplied in a charging direction with the current density of 1 mA/cm² to store hydrogen in the hydrogen electrode. Then, a discharging operation was carried out with the current density of 1 mA/cm². As a result, the discharge characteristics as shown in FIG. 5 could be obtained and a function as the hydrogen-air fuel cell was recognized.

It is to be understood that the present invention is not limited to the above described embodiments and Examples and various kinds of changes may be performed within the scope of the present invention defined in claims and they may be also involved in the scope of the invention.

For example, in the above described embodiments, although the fuel cell using the hydrogen-storing carbonaceous material and the hydrogen-stored carbonaceous material was described, the hydrogen-storing carbonaceous material and the hydrogen-stored carbonaceous material according to the present invention are not limited to the fuel cell but also may be widely applied to uses for hydrogen storage as well as other batteries such as an alkaline storage battery, a hydrogen-air fuel cell, etc.

### INDUSTRIAL APPLICABILITY

According to the present invention, there can be provided a hydrogen-storing carbonaceous material which can efficiently store a large amount of hydrogen, is light and safe, can be repeatedly used and may not possibly generate problems in view of resources and an environment and a method for producing it, a hydrogen-stored carbonaceous material and a method for producing it, a battery using a hydrogen-stored carbonaceous material and a fuel cell using a hydrogen-stored carbonaceous material.

1. A hydrogen-storing carbonaceous material obtainable by heating a carbonaceous material before hydrogen is stored under the pressure of hydrogen lower than 50 atmospheric pressure.

2. The hydrogen-storing carbonaceous material according to claim 1, obtainable by heating the carbonaceous material before hydrogen is stored under the pressure of hydrogen of 10 atmospheric pressure or lower.

3. The hydrogen-storing carbonaceous material according to claim 1, obtainable by heating the carbonaceous material at more than 100° C.

4. The hydrogen-storing carbonaceous material according to claim 3, obtainable by heating the carbonaceous material at from 200° C. to 1200° C.

5. The hydrogen-storing carbonaceous material according to claim 4, obtainable by heating the carbonaceous material at from 600° C. to 1200° C.

6. The hydrogen-storing carbonaceous material according to claim 5, obtainable by heating the carbonaceous material at from 800° C. to 1000° C.

7. The hydrogen-storing carbonaceous material according to claim 1, obtainable by heating the carbonaceous material under the atmosphere of inert gas.

8. The hydrogen-storing carbonaceous material according to claim 7, wherein the inert gas is selected from a group consisting of nitrogen gas, helium gas, neon gas, argon gas, krypton gas, xenon gas and radon gas.

9. The hydrogen-storing carbonaceous material according to claim 1, wherein the carbonaceous material has a large surface and a structural curvature.

10. The hydrogen-storing carbonaceous material according to claim 9, wherein the carbonaceous material is selected from a group consisting of fullerene, carbon nanofiber, carbon nanotube, carbon soot, nanocapsule, bucky onion and carbon fiber.

11. A producing method of a hydrogen-storing carbonaceous material comprising a step of heating a carbonaceous material before hydrogen is stored under the pressure of hydrogen lower than 50 atmospheric pressure.

12. The producing method of a hydrogen-storing carbonaceous material according to claim 11, obtainable by heating the carbonaceous material is heated before hydrogen is stored under the pressure of hydrogen of 10 atmospheric pressure or lower.

13. The producing method of a hydrogen-storing carbonaceous material according to claim 11, obtainable by heating the carbonaceous material at more than 100° C.

14. The producing method of a hydrogen-storing carbonaceous material according to claim 13, obtainable by heating the carbonaceous material at from 200° C. to 1200° C.

15. The producing method of a hydrogen-storing carbonaceous material according to claim 14, obtainable by heating the carbonaceous material at from 600° C. to 1200° C.

16. The producing method of a hydrogen-storing carbonaceous material according to claim 15, obtainable by heating the carbonaceous material at from 800° C. to 1000° C.

17. The producing method of a hydrogen-storing carbonaceous material according to claim 11, obtainable by heating the carbonaceous material under the atmosphere of inert gas.

18. The producing method of a hydrogen-storing carbonaceous material according to claim 17, wherein the inert gas is selected from a group consisting of nitrogen gas, helium gas, neon gas, argon gas, krypton gas, xenon gas and radon gas.

19. The producing method of a hydrogen-storing carbonaceous material according to claim 11, wherein the carbonaceous material has a large surface and a structural curvature.

20. The producing method of a hydrogen-storing carbonaceous material according to claim 19, wherein the carbonaceous material is selected from a group consisting of fullerene, carbon nanofiber, carbon nanotube, carbon soot, nanocapsule, bucky onion and carbon fiber.

21. A hydrogen-stored carbonaceous material obtainable by heating a carbonaceous material to store hydrogen under the pressure of hydrogen lower than 50 atmospheric pressure.

22. The hydrogen-stored carbonaceous material according to claim 21, obtainable by heating the carbonaceous material to store hydrogen under the pressure of hydrogen of 10 atmospheric pressure or lower.

23. The hydrogen-stored carbonaceous material according to claim 21, obtainable by heating the carbonaceous material at more than 100° C. and lower than 1500° C.

24. The hydrogen-stored carbonaceous material according to claim 23, obtainable by heating the carbonaceous material at from 200° C. to 1200° C.

25. The hydrogen-stored carbonaceous material according to claim 24, obtainable by heating the carbonaceous material at from 600° C. to 1200° C.

26. The hydrogen-stored carbonaceous material according to claim 25, obtainable by heating the carbonaceous material at from 800° C. to 1000° C.

27. The hydrogen-stored carbonaceous material according to claim 21, obtainable by heating the carbonaceous material under the atmosphere of inert gas.

28. The hydrogen-storing carbonaceous material according to claim 27, wherein the inert gas is selected from a group consisting of nitrogen gas, helium gas, neon gas, argon gas, krypton gas, xenon gas and radon gas.

29. The hydrogen-stored carbonaceous material according to claim 21, wherein the carbonaceous material has a large surface and a structural curvature.

30. The hydrogen-storing carbonaceous material according to claim 29, wherein the carbonaceous material is selected from a group consisting of fullerene, carbon nanofiber, carbon nanotube, carbon soot, nanocapsule, bucky onion and carbon fiber.

31. A producing method of a hydrogen-stored carbonaceous material comprising of a step of heating a carbonaceous material to store hydrogen under the pressure of hydrogen lower than 50 atmospheric pressure.

32. The producing method of a hydrogen-stored carbonaceous material according to claim 31, obtainable by heating the carbonaceous material to store hydrogen under the pressure of hydrogen of 10 atmospheric pressure or lower.

33. The producing method of a hydrogen-stored carbonaceous material according to claim 31, obtainable by heating the carbonaceous material at more than 100° C. and lower than 1500° C.

34. The producing method of a hydrogen-stored carbonaceous material according to claim 33, obtainable by heating the carbonaceous material at from 200° C. to 1200° C.

35. The producing method of a hydrogen-stored carbonaceous material according to claim 34, obtainable by heating the carbonaceous material at from 600° C. to 1200° C.

36. The producing method of a hydrogen-stored carbonaceous material according to claim 35, characterized in that the carbonaceous material is heated at from 800° C. to 1000° C.

37. The producing method of a hydrogen-stored carbonaceous material according to claim 31, obtainable by heating the carbonaceous material under the atmosphere of inert gas.

38. The producing method of a hydrogen-stored carbonaceous material according to claim 37, wherein the inert gas is selected from a group consisting of nitrogen gas, helium gas, neon gas, argon gas, krypton gas, xenon gas and radon gas.

39. The producing method of a hydrogen-stored carbonaceous material according to claim 31, wherein the carbonaceous material has a large surface and a structural curvature.

40. The producing method of a hydrogen-stored carbonaceous material according to claim 39, wherein the carbonaceous material is selected from a group consisting of fullerene, carbon nanofiber, carbon nanotube, carbon soot, nanocapsule, bucky onion and carbon fiber.

41. A battery having an anode, a cathode and an electrolyte provided therebetween, wherein the anode and/or the cathode includes a hydrogen-stored carbonaceous material obtainable by heating a carbonaceous material to store hydrogen under the pressure of hydrogen lower than 50 atmospheric pressure.

42. The battery according to claim 41, including a hydrogen-stored carbonaceous material obtainable by heating the carbonaceous material to store hydrogen under the pressure of hydrogen of 10 atmospheric pressure or lower.

43. The battery according to claim 41, obtainable by heating the carbonaceous material at more than 100° C. and lower than 1500° C.

44. The battery according to claim 43, obtainable by heating the carbonaceous material at from 200° C. to 1200° C.

45. The battery according to claim 44, obtainable by heating the carbonaceous material at from 600° C. to 1200° C.

46. The battery according to claim 45, obtainable by heating the carbonaceous material at from 800° C. to 1000° C.

47. The battery according to claim 41, obtainable by heating the carbonaceous material under the atmosphere of inert gas.

48. The battery according to claim 47, wherein the inert gas is selected from a group consisting of nitrogen gas, helium gas, neon gas, argon gas, krypton gas, xenon gas and radon gas.

49. The battery according to claim 41, wherein the carbonaceous material has a large surface and a structural curvature.

50. The battery according to claim 49, wherein the carbonaceous material is selected from a group consisting of fullerene, carbon nanofiber, carbon nanotube, carbon soot, nanocapsule, bucky onion and carbon fiber.

51. A fuel cell having a laminated structure of an anode, a proton conductor and a cathode, and a hydrogen storage part including a hydrogen-stored carbonaceous material obtainable by heating a carbonaceous material to store hydrogen under the pressure of hydrogen lower than 50 atmospheric pressure, discharging hydrogen and supplying it to the anode.

52. The fuel cell according to claim 51, including the hydrogen-stored carbonaceous material obtainable by heating the carbonaceous material to store hydrogen under the pressure of hydrogen lower than 50 atmospheric pressure.

53. The fuel cell according to claim 51, obtainable by heating the carbonaceous material at more than 100° C. and lower than 1500° C.

54. The fuel cell according to claim 53, obtainable by heating the carbonaceous material at from 200° C. to 1200° C.

55. The fuel cell according to claim 54, obtainable by heating the carbonaceous material at from 600° C. to 1200° C.

56. The fuel cell according to claim 55, obtainable by heating the carbonaceous material at from 800° C. to 1000° C.

57. The fuel cell according to claim 51, obtainable by heating the carbonaceous material under the atmosphere of inert gas.

58. The fuel cell according to claim 57, wherein the inert gas is selected from a group consisting of nitrogen gas, helium gas, neon gas, argon gas, krypton gas, xenon gas and radon gas.

59. The fuel cell according to claim 51, wherein the carbonaceous material has a large surface and a structural curvature.

60. The fuel cell according to claim 59, wherein the carbonaceous material is selected from a group consisting of fullerene, carbon nanofiber, carbon nanotube, carbon soot, nanocapsule, bucky onion and carbon fiber.
